(19) United States
(12) Patent Application Publication
(10) Pub. No.: US 2017/0362139 A1
(43) Pub. Date: Dec. 21, 2017

(54) NITRIFICATION INHIBITOR COMPOSITIONS AND METHODS FOR PREPARING THE SAME

(71) Applicant: DOW AGROSCIENCES LLC, Indianapolis, IN (US)

(72) Inventors: Shiling Zhang, Shanghai (CN); Yonnie Yun, Shanghai (CN); Tong Sun, Shanghai (CN); Christine Lao, Shanghai (CN); Job Jan Samson, Missouri City, TX (US); Lei Liu, Indianapolis, IN (US); Eliza Yuan, Shanghai (CN); Jian Zou, Shanghai (CN); Jianping Xu, Shanghai (CN)

(21) Appl. No.: 15/535,025

(22) PCT Filed: Dec. 11, 2015
(86) PCT No.: PCT/CN2015/097093

§ 371 Date: Jun. 9, 2017

(30) Foreign Application Priority Data
Dec. 11, 2014 (CN) PCT/CN2014/093583

(51) Int. Cl. C05G 3/08; C05C 9/00; A01N 43/40; C05G 3/00; A01N 25/26

(52) U.S. Cl. CPC C05G 3/08; C05G 3/0041; C05G 3/0029; A01N 25/26; A01N 43/40; C05C 9/00

(57) ABSTRACT

The present disclosure relates to enhanced nitrification inhibitor dry fertilizer compositions, methods for making the same, and their use in agricultural applications.

### FIELD OF THE INVENTION

The present disclosure relates to compositions that inhibit nitrification and methods of making the same. In some aspects, these compositions are formulated to include other agriculturally active compounds, such as nitrogen-rich fertilizers.

### BACKGROUND AND SUMMARY

Nitrogen fertilizer added to the soil is readily transformed through a number of undesirable biological and chemical processes, including nitrification, leaching, and evaporation. Many of these transformation processes reduce the level of nitrogen available for uptake by the targeted plant. One such process is nitrification, a process by which certain widely occurring soil bacteria metabolize the ammonium form of nitrogen in the soil, transforming the nitrogen into nitrite and nitrate forms of nitrogen, which are more susceptible to loss from the soil through leaching or volatilization.

The decrease in available nitrogen due to nitrification necessitates the addition of more nitrogen rich fertilizer to compensate for the loss of agriculturally active nitrogen available to the plants. These concerns intensify the demand for improved management of nitrogen, in order to reduce costs associated with the use of additional nitrogen fertilizer.

Methods for reducing nitrification include treating soil with agriculturally active compounds that inhibit or at least reduce the metabolic activity of at least some microbes in the soil that contribute to nitrification. These compounds include (Trichloromethyl) pyridines, such as nitrapyrin, which have been used as nitrification inhibitors in combination with fertilizers as described in U.S. Pat. No. 3,135,594, the disclosure of which is incorporated herein by reference in its entirety. These compounds help to maintain agriculturally-applied ammonium nitrogen in the ammonium form (stabilized nitrogen), thereby enhancing plant growth and crop yield. These compounds have been used efficaciously with a number of plant crops including corn, sorghum, and wheat.

Compounds such as nitrapyrin are unstable in soil in part because they are very volatile. For example, nitrapyrin has a relatively high vapor pressure (2.8×10⁻³ mm Hg at 23° Celsius), and because of this it has a tendency to volatilize and must be applied immediately or somehow protected from rapid loss after the fertilizer is treated with nitrapyrin. One approach is to add nitrapyrin to a volatile fertilizer, namely anhydrous ammonia which itself must be added to the soil in manner that reduces the amount of the volatile active lost to the atmosphere. This method is problematic in that it requires the use of anhydrous ammonia, which is corrosive and must be injected into the soil. This method of applying nitrapyrin, while stabilizing nitrapyrin below the soil surface, is not preferred. This method is unsuitable for many other fertilizer types and their standard application practices such as dry fertilizer granules, which most often are broadcasted onto the soil surface.

Still other approaches to stabilize nitrapyrin and reduce its loss to the atmosphere include applying it to the surface of the soil and then mechanically incorporating it into the soil, or watering it into the soil generally within 8 hours after its application to reduce its loss to the atmosphere. Still another approach is to encapsulated nitrapyrin for rapid or dump release. Such encapsulated forms of nitrapyrin have been formulated with lignin sulfonates as disclosed in U.S. Pat. No. 4,746,513, the disclosure of which is incorporated herein by reference in its entirety. While these formulations are less volatile than simple nitrapyrin, these formulations are better suited for use with liquid urea ammonium nitrate (“UAN”) or liquid manure fertilizers than with dry fertilizers.

Another approach to stabilizing nitrapyrin includes polycondensation encapsulation. Additional information regarding this approach can be found in U.S. Pat. No. 5,925,464, the disclosure of which is incorporated herein by reference in its entirety. Some of these formulations enhance handling safety and storage stability of the nitrapyrin using polyurethane rather than polyurea to form at least a portion of the capsule shell.

In some instances, polyurea has been used to produce enhanced nitrification inhibitor compositions for delayed, steady release of nitrification inhibitors for application with fertilizers. Such encapsulated forms of nitrapyrin are disclosed in U.S. Pat. No. 8,377,849 and U.S. Pat. No. 8,741,805, the disclosures of which are incorporated herein by reference in their entirety.

Independent application of nitrification inhibitors such as nitrapyrin has some drawbacks. Many farmers are reluctant to separately apply a nitrogen fertilizer and a nitrification inhibitor composition because: (1) such separate application consumes considerable time and human resources; (2) there is a large potential for non-uniform distribution of nitrapyrin, which may lead to performance loss and ineffective use of nitrapyrin; and (3) there is an uncontrolled fertilizer to inhibitor ratio in soil, which may lead to performance loss.

Accordingly, nitrapyrin and nitrogen based fertilizes may be applied at the same time by mixing the compounds and applying them from a common reservoir. Premixing many formulations of nitrapyrin with fertilizers also may have certain disadvantages including: (1) extra time, human resources, and cost in the premixing process; (2) difficulty in combining dry fertilizer granules, such as, for example, urea granules, with nitrapyrin products commonly sold in emulsifiable concentrate (“EC”) or capsule suspension (“CS”) liquid form; (3) large differences in application rates, which make preparation of homogeneous blends difficult, for example, the application rate of nitrogen fertilizers (in some embodiments about 20-50 kg/Mu, such as, for example, urea) is hundreds of times that of nitrification inhibitors such as nitrapyrin (for example Entrench®, which is about 170 ml/Mu); and (4) only temporary stability against volatilization loss for nitrapyrin products, commercially available such as Instinct® or Entrench®, when impregnated onto fertilizer granules, such as, for example, urea. Such fertilizer product must be applied shortly after impregnation to minimize the loss of performance.

Furthermore, water in many preparations of nitrapyrin may cause problems such as the attachment and crystallization of urea particles, and therefore there may be an advantage to avoiding use of liquid concentrates (EC or CS) of nitrapyrin with nitrogen fertilizer granules, such as urea.

While considerable progress has been made in the delivery and stability of nitrification inhibitors such as nitrapyrin, there remains a need for still more efficacious formulations of compounds such as (trichloromethyl) pyridines. There remains a special need for compositions that effectively include at least one agriculturally active ingredient (“AI”) in addition to the nitrification inhibitor that that can be applied along with agricultural actives such as nitrogen fertilizers without the need additional mixing and/or application steps.

Some aspects of the invention include compositions that include one or more nitrogen fertilizers with one or more nitrification inhibitors. In some embodiments, encapsulated nitrapyrin is applied to the surface of fertilizer particles or granules, with one or more particulates, optionally hygroscopic particulate which may act to reduce volatilization of volatile compounds, such as, for example, nitrapyrin, and optionally inorganic hygroscopic particulate which may also act to reduce volatilization of volatile compounds.

Such dry fertilizer/nitrification inhibitor compositions increase ease-of-use, exhibit controlled release of nitrification inhibitor and nitrogen, increase fertilizer efficiency, and decrease pollution of the soil, water, and air by reducing nitrification. Some of the inventive compositions disclosed herein also exhibit good nitrapyrin stability. Some compositions exhibit increased stability even at elevated temperatures.

Some embodiments of the invention include granules of urea. Still other embodiments may include other fertilizers such as other formulations of nitrogen, and/or phosphorous, and/or potassium and/or combinations of two or more or all three (“NPK”) fertilizers, and/or bulk blends of fertilizers. In some embodiments, the agriculturally active ingredient includes compounding fertilizers, potassium salts, potash, micronutrients, and physical blends of any of the preceding fertilizers. The inventive formulations and compositions can be surface broadcasted or sub-surface incorporated, and can be applied before, during, or after planting of one or more crops.

Disclosed herein are agriculturally active compositions, comprising: a substantially solid core, the core optionally having at least one agriculturally active ingredient and an outer surface; a plurality of encapsulated particles disposed around the outer surface, the particles including at least one inhibitor of nitrification; and hygroscopic particulate disposed around the plurality of encapsulated particles. In some embodiments, the hygroscopic particulate is not in contact with the core. In other embodiments, the core includes at least one agricultural active ingredient selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof.

Still in other embodiments, the core comprises a solid form of urea. In yet other embodiments, the encapsulated particles comprise nitrapyrin. In some exemplary embodiments, the encapsulated particles include polyurea and have a volume median particle size of from about 1 to about 10 microns. In other embodiments, the hygroscopic particulate is an inorganic hygroscopic particulate. In some embodiments, the hygroscopic particulate is at least one compound selected from the group consisting of: attapulgite, talc, diatomite, kaolin, silica, clay, mica, bentonite, montmorillonite, white carbon black, carbon black, coal ash, plant ash, wollastonite, zeolite, sepiolite, vermiculite perlite, starch, wax, and mixtures thereof. In some embodiments, the hygroscopic particulate acts to absorb moisture. In some embodiments, the hygroscopic particulate acts to prevent agglomeration between multiple core particles. In some embodiments, the hygroscopic particulate acts to reduce volatilization of volatile compounds, preventing or reducing volatilization of the core particle and/or the inhibitor of nitrification. In some embodiments, the hygroscopic particles in the presence of water may dissociate from the inventive compositions.

Still in other embodiments, the composition comprises a binder, said binder being disposed predominately on the outer surface of the core and said binder immobilizing the plurality of the encapsulated particles. In some embodiments, the binder is at least one compound selected from the group consisting of: hydroxypropyl methylcellulose, ethyl cellulose, methyl cellulose, carboxymethyl cellulose, polyvinyl alcohol, polyvinylpyrrolidone, polyoxyethylene and its copolymers, latexes, polyamides, sugar, glucose, maltose, starch, lignosulfonates, guar, urea, alginate, polysaccharides, aqueous polyester, polyethers, epoxy resin, isocyanates, ethylene vinyl acetate copolymer, polyacrylate and its copolymer emulsions, and mixtures thereof. In some embodiments, the binder comprises hydroxypropyl methylcellulose. In some embodiments, the binder comprises any combination of one or more of hydroxypropyl methylcellulose, polyvinyl alcohol, and urea.

In some embodiments, the composition comprises between about 80% and about 99% by weight of fertilizer granules. In some preferred embodiments, the composition comprises between about 90% and about 99% by weight of fertilizer granules.

In some embodiments, the composition comprises nitrapyrin in a range between any lower concentration selected from about: 0.01% wt., 0.05% wt., 0.10% wt., 0.20% wt., 0.30% wt., 0.40% wt., and 0.50% wt. and any upper concentration selected from about: 10.00% wt., 5.00% wt., 4.00% wt., 3.00% wt., 2.50% wt., 2.00% wt., and 1.00% wt. In some embodiments, the composition comprises nitrapyrin in a range selected from the group of ranges consisting of: about 0.01% wt. to about 10.00% wt.; about 0.05% wt. to about 5.00% wt.; about 0.10% wt. to about 4.00% wt.; about 0.20% wt. to about 3.00% wt.; about 0.30% wt. to about 2.50% wt.; about 0.40% wt. to about 2.00% wt.; and about 0.50% wt. to about 1.00% wt.

Still in yet other embodiments, the composition comprises between about 0.01% and about 10% by weight of the binder.

In some embodiments, the composition comprises between about 0.01% and about 5% of the binder. In other embodiments, the composition comprises between about 1.00% and about 10.00% of the hygroscopic particulate. In some exemplary embodiments, the composition comprises between about 2.00% and about 7.00% of the hygroscopic particulate. Still in other embodiments, the composition comprises particles of a volume median particle size of from about 0.5 to about 5 millimeters. In other embodiments, the ratio of the binder to the agriculturally active ingredient is from about 0:100 to about 1:100.

Still in other embodiments, the ratio of the binder to the agriculturally active ingredient in the composition is from about 0:100 to about 0.3:100. In yet other embodiments, the ratio of the inhibitor of nitrification to the fertilizer is from about 0.01:100 to about 3:100. Still in other embodiments, the ratio of the inhibitor of nitrification to the fertilizer is from about 0.2:100 to about 2.0:100. In some exemplary embodiments of the composition, the ratio of the hygroscopic particulate to the fertilizer is from about 1:500 to about 20:100. Still in yet other embodiments, the ratio of the hygroscopic particulate to the fertilizer is from about 1:100 to about 10:100.

Additionally disclosed herein are some methods for preparing agriculturally active compositions comprising the steps of: preparing a solution comprising a plurality of encapsulated particles, the particles including at least one inhibitor of nitrification and coating a plurality of substantially solid core particles, the core particles optionally having at least one agriculturally active ingredient and having an outer surface, with the solution to create coated combined particles.

In some embodiments, the method further comprises the step of adding a binder to the solution. In other embodiments, the preparing step further comprises dissolving fertilizer granules within the solution. Still in other embodiments, the method comprises the step of drying the combined particles. Still in other embodiments, the core particles comprise at least one agriculturally active ingredient are selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof. In some embodiments, the core particles comprise urea.

In still yet other embodiments, the encapsulated particles comprise nitrapyrin. In some embodiments, the encapsulated particles comprise polyurea and have a volume median particle size of from about 1 to about 10 microns. In other embodiments, the binder is at least one compound selected from the group consisting of: hydroxypropyl methylcellulose, ethyl cellulose, methyl cellulose, carboxymethylcellulose, polyvinyl alcohol, polyvinylpyrrolidone, polyoxyethylene and its copolymers, latexes, polyamides, sugar, glucose, maltose, starch, lignosulfonates, guar, urea, alginate, polysaccharides, aqueous polyester, polyethers, epoxy resin, isocyanates, ethylene vinyl acetate copolymer, polyacrylate and its copolymer emulsions, and mixtures thereof. Still in other embodiments, the solution comprises hydroxypropyl methylcellulose, polyvinyl alcohol, and water.

In other exemplary embodiments, the method further comprises the step of adding hygroscopic particulate to be disposed on the coated combined particles. In some embodiments, the hygroscopic particulate is inorganic hygroscopic particulate. In other embodiments, the hygroscopic particulate is at least one compound selected from the group consisting of: attapulgite, talc, diatomite, kaolin, silica, clay, mica, bentonite, montmorillonite, white carbon black, carbon black, coal ash, plant ash, wollastonite, zeolite, sepiolite, vermiculite perlite, starch, wax, and mixtures thereof. In some embodiments, the hygroscopic particulate acts to absorb moisture. In some embodiments, the hygroscopic particulate acts to prevent agglomeration between multiple core particles. In some embodiments, the hygroscopic particulate acts to prevent or reduce volatilization of the core particle and/or inhibitor of nitrification.

In other embodiments, the composition comprises between about 80% and about 99% by weight of core particles. In still other embodiments, the composition comprises between about 90% and about 99% by weight of core particles. In other embodiments, the composition comprises between about 0.10% and about 2.00% of nitrapyrin.

In still other embodiments of the method, the composition comprises nitrapyrin in a range between any lower concentration selected from about: 0.01% wt., 0.05% wt., 0.10% wt., 0.20% wt., 0.30% wt., 0.40% wt., and 0.50% wt. and any upper concentration selected from about: 10.00% wt., 5.00% wt., 4.00% wt., 3.00% wt., 2.50% wt., 2.00% wt., and 1.00% wt. In some embodiments, the composition comprises between about 0.01% and about 10.00% of the binder. In other embodiments, the composition comprises between about 0.01% and about 5.00% of the binder. Still in other embodiments, the composition comprises between about 1.00% and about 10.00% of the hygroscopic particulate. Still in other embodiments, the composition comprises between about 2.00% and about 7.00% of the hygroscopic particulate. In yet other embodiments, the composition comprises coated combined particles of a volume median particle size of from about 0.5 to about 5 millimeters.

In still other embodiments, the ratio of the binder to the core particles is from about 0:100 to about 1:100. In some embodiments, the ratio of the binder to the core particles is from about 0:100 to about 0.3:100. In some exemplary embodiments, the ratio of the inhibitor of nitrification to the core particles is from about 0.01:100 to about 5:100. In other embodiments, the ratio of the inhibitor of nitrification to the core particles is from about 0.2:100 to about 2.0:100. In yet other embodiments, the ratio of the hygroscopic particulate to the core particles is from about 1:500 to about 20:100.

In still other embodiments, the ratio of the hygroscopic particulate to the core particles is from about 1:100 to about 10:100. In yet other embodiments, the step of coating incorporates one or more devices selected from the group consisting of: a pan coater, a rotating drum, a spray coater, a fluid bed, and screens.

### BRIEF DESCRIPTION OF THE FIGURES

The features of this disclosure, and the manner of attaining them, will become more apparent and the disclosure itself will be better understood by reference to the following description of embodiments of the disclosure taken in conjunction with the accompanying drawings.

FIG. 1 provides a simplified, representative side cut-away view of one exemplary embodiment of a particle that includes a nitrification inhibitor and a core which may optionally include at least one agriculturally active ingredient.

FIG. 2 provides a process diagram for one exemplary method of preparing a particle that includes a nitrification inhibitor and a core which optionally includes at least one agriculturally active ingredient.

FIGS. 3A-C provide a photographic comparison of urea granules to one exemplary embodiment of the inventive particles, the particles being comprised of a core which includes granulated urea coated with a composition that includes the nitrification inhibitor nitrapyrin.

FIGS. 4A-D provide enlarged images of the morphology of the coated urea granule of the composition recited in Example 2 of this disclosure.

FIG. 5 provides a chart showing percent change in weight as a function of time of a dried Instinct® capsule suspension (polyurea-encapsulated nitrapyrin by Dow AgroSciences LLC) stored at 54° C.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION

(Trichloromethyl) pyridine compounds useful in the composition of the present disclosure include compounds having a pyridine ring which is substituted with at least one trichloromethyl group and mineral acid salts thereof. Suitable compounds include those containing chlorine or methyl substituents on the pyridine ring in addition to a trichloromethyl group, and are inclusive of chlorination products of methyl pyridines such as lutidine, collidine and picoline. Suitable salts include hydrochlorides, nitrates, sulfates and phosphates. The (trichloromethyl) pyridine compounds useful in the practice of the present disclosure are typically oily liquids or crystalline solids dissolved in a solvent. Other suitable compounds are described in U.S. Pat. No. 3,135,594. A preferred (trichloromethyl) pyridine is 2-chloro-6-(trichloromethyl) pyridine, also known as nitrapyrin, and the active ingredient of the product N-SERVE™. (Trademark of Dow AgroSciences LLC).

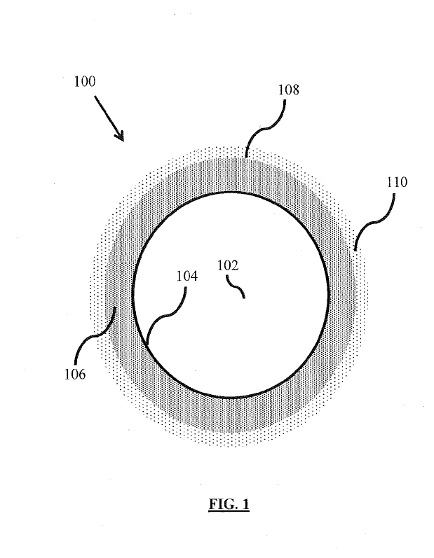

Referring now to FIG. 1, a side cut-away view of one exemplary embodiment of an enhanced nitrification inhibitor dry fertilizer combined particle is shown. Combined particle 100 includes core 102, which in some embodiments may be an agriculturally active (“AI”) compound, and in some embodiments is an agriculturally active (“AI”) granule. In other embodiments, core 102 may be an inert core, such as, for example, a particle of sand.

Combined particle 100 also includes Nitrification Inhibiting (“NI”) interface 104, NI layer 106, NI-hygroscopic particulate (“HP”) interface 108, and HP layer 110. Particle 100 is shown to be substantially spherically shaped (substantially circular in the cross-section), however, any other suitable shape is envisioned, such as, for example, a cylinder, cube, square in the cross-section, and/or ellipse in the cross-section, so long as particle 100 can be applied to fields and/or crops and release the composition into the soil.

Core 102 forms the core or inner-most substituent of particle 100, and in some embodiments is any suitable agricultural active compound, such as, for example, dry fertilizer for application to fields and/or crops, such as, for example, a nitrogen-containing fertilizer such as urea. Core 102 can also include any other agricultural active ingredients including, but not limited to, pesticides, fungicides, herbicides, miticides, insecticides, safeners, arthropocides, and mixtures thereof. In other embodiments, core 102 may be an inert substance.

In some embodiments, core 102 comprises at least one of a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and a mixture thereof and/or any blend or mixture of the foregoing. Such exemplary embodiments may be in dry granular form.

In some embodiments, core 102 comprises urea. The volume median particle size of core 102 can be similar to the size of commercially available dry fertilizer products, such as between about 0.1 mm to about 10 mm, preferably from about 0.1 mm to about 7 mm, and more preferably from about 0.1 mm to about 5 mm, and for nitrogen-based fertilizers, such as, for example, urea between about 0.3 mm and about 3 mm.

NI layer 106, in the embodiment shown, wholly covers core 102 creating NI interface 104 around the outer surface of core 102. In other embodiments, NI layer 106 need not wholly cover core 102. For example, in some embodiments, portions of core 102 may be open to the atmosphere where NI layer 106 is discontinuous. NI layer 106 includes at least one nitrification inhibiting active ingredient, such as, for example, nitrapyrin. In some embodiments, NI layer 106 includes microcapsules comprising nitrapyrin. Such microcapsules can be those microcapsules disclosed and claimed in U.S. Pat. No. 8,377,849 and U.S. Pat. No. 8,741,805. In some embodiments, the microcapsules include polyurea and are between about 1 μm and about 10 μm in size.

NI layer 106 may optionally include any aqueous, oil-based, and/or polymeric substance, which allows at least one nitrification inhibiting compound, such as nitrapyrin, to be disposed around core 102. Exemplary optional binders suitable for use with NI layer 106 include, but are not limited to hydroxypropyl methylcellulose (“HPMC”), ethyl cellulose (“EC”), methyl cellulose (“MC”), carboxymethyl cellulose (“CMC”), polyvinyl alcohol (“PVA”), polyvinylpyrrolidone (“PVP”), polyoxyethylene and its copolymers, latexes, polyamides, sugar, glucose, maltose, starch, lignosulfonates, guar, urea, alginate, polysaccharides, aqueous polyester, polyethers, epoxy resin, isocyanates, ethylene vinyl acetate copolymer, polyacrylate and its copolymer emulsions, water-soluble agricultural active ingredients in aqueous solvent, oil-soluble agricultural active ingredients in oil solvent, and mixtures thereof.

Any optional binder is envisioned that is capable of holding the microcapsules around the outer surface of core 102 and is capable of dissolving and/or releasing the nitrification inhibitor, which in some embodiments is microencapsulated, and the agricultural active core, in some embodiments fertilizer, once particle 100 is applied to a field or crop. The optional binder can be used to help immobilize nitrification inhibitors, optionally encapsulated nitrapyrin, around a core particle, such as core 102. The binder can also help adhere particulate, such as hygroscopic particulate, around NI layer 106. Furthermore, binder may be used to adjust the formulation's viscosity and/or flowability.

HP layer 110 is shown, which forms NI-HP interface 108 around NI layer 106. In some embodiments, no HP layer is used with combined particle 100. In other embodiments, HP layer 110 is discontinuous around NI layer 106. HP layer 110 can include particles that absorb moisture during manufacturing, storage, transport, and/or field use of combined particles 100. Hygroscopic particles, in some embodiments, function to absorb moisture and prevent agglomeration between combined particles during manufacturing, storage, transport, and/or field use of combined particles 100. In some embodiments, the hygroscopic particles form a volatilization barrier to reduce volatilization of volatile compounds, either by themselves or in combination with a binder, to reduce and/or prevent the volatilization of nitrification inhibitor from NI layer 106 and/or the volatilization of core 102.

Hygroscopic particulates can include, but are not limited to, one or more of attapulgite, talc powder, diatomite, kaolin, silica, clay, mica, bentonite, montmorillonite, white carbon black, carbon black, coal ash, plant ash, wollastonite, zeolite, sepiolite, vermiculite perlite, starch, wax, and mixtures thereof. Any material is envisioned as being used for a HP, so long as the material can coat the outer layer of NI layer 106, and is capable of dissolving and/or releasing the NI layer, and agricultural active ingredient, such as, for example, fertilizer, once particle 100 is applied to a field or crop.

The hygroscopic particulates, in some embodiments, serve in part as a drying agent to avoid core particle agglomeration, which may be caused by sticking between the nitrification inhibitor layers of different core particles. The particulate can also serve as a protectant for the nitrification inhibiting layer, optionally containing encapsulated nitrapyrin, by preventing the nitrification inhibitor from peeling away from the core particle by mechanical abrasion. The hygroscopic particulate layer, in some embodiments, serves as a layer of protection to reduce the sensitivity of the combined particles to the environment, such as the environment during processing, storage, shipping, and use. In some embodiments, the hygroscopic particulate layer aids in reducing the volatility of the core particle and/or the nitrification inhibiting layer.

Any portion of combined particle 100, including core 102, NI layer 106, and/or HP layer 110 may contain any other physically compatible agricultural active ingredient including, but not limited to, fungicides, herbicides, miticides, insecticides, safeners, arthropocides, and mixtures or blends of any of the foregoing. Physically compatible agricultural active ingredients include any AI that can be formulated with combined particle 100 for stable storage, transport, and distribution to a field and for suitable, consistent release of combined particle 100 to the soil, field, and/or crop.

In some embodiments, microencapsulated nitrapyrin particles, encapsulated with polyurea, are coated on the surface of urea or other dry fertilizer granules/particles, for use in fields and/or crops. In some embodiments, combined particle 100 is a dry formulation. In some embodiments, core 102, NI layer 106, and HP layer 110 will dissolve and/or dissociate in water (in soil conditions) and then release encapsulated nitrapyrin. Nitrapyrin will then diffuse into the soil to function as an inhibitor for nitrification of AI's, optionally nitrogen-containing fertilizers.

In some embodiments of combined particle 100, the ratio of the hygroscopic particulate to the urea and/or fertilizer and/or AI is from about 1:500 to about 20:100, preferably from about 1:100 to about 10:100. In some embodiments, the ratio of the binder to the urea and/or fertilizer and/or AI is from about 0:100 to about 10:100, preferably from about 0.1:100 to about 5:100. In some embodiments, the ratio of the nitrification inhibitor, optionally nitrapyrin, to the urea and/or fertilizer and/or AI is from about 0.01:100 to about 3:100, preferably from about 0.2:100 to about 2.0:100.

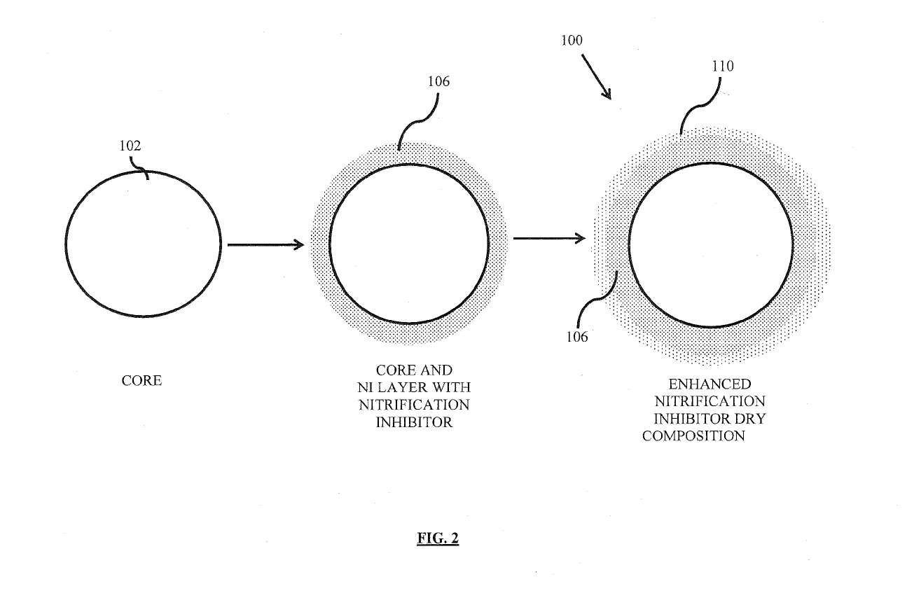

Referring now to FIG. 2, a process diagram for one exemplary method of preparing an enhanced nitrification inhibitor dry fertilizer combined particle is shown. In the embodiment shown, core 102 is provided, which in some embodiments is a dry fertilizer granule, such as urea. In the next step, a binder solution or coating liquid is prepared to partially or wholly coat core 102. In some embodiments, the binder solution or coating liquid is an aqueous suspension of microencapsulated nitrapyrin, such as Entrench® and/or Instinct®.

In one exemplary embodiment, HPMC powder is dispersed into water by stirring at 200-1500 rpm for 5 minutes, and the mixture is then incubated at 60-90 degrees Celsius for about 10 minutes with stirring at 500-2000 rpm. The mixture is then cooled down and further dispersed under shearing until the powder is completely dissolved.

In another exemplary embodiment, PVA powder is dispersed into water by stirring at 200-1500 rpm for 5 minutes, and the mixture is then incubated at 60-90 degrees Celsius for about 10 minutes with stirring at 500-2000 rpm. The mixture is then cooled down and further dispersed under shearing until the powder is completely dissolved.

The binder solution or coating liquid may comprise both solutions above including HPMC and PVA, but in other embodiments the binder solution or coating liquid may comprise only one polymeric binder, multiple polymeric binders, or no polymeric binders. In some embodiments, following the preparation of a binder solution or coating liquid with polymeric binders, a water suspension of encapsulated nitrapyrin (such as, for example, Entrench® and/or Instinct® by Dow AgroSciences LLC) is mixed with the binder solution or coating liquid at room temperature. Optionally, one or more agriculturally active ingredients, such as urea, can also be added to the binder solution, optionally with water or other solvents, such as oil, to dissolve the one or more agricultural active ingredients in the binder solution.

In some embodiments, a water suspension of encapsulated nitrapyrin (such as, for example, Entrench® and/or Instinct® by Dow AgroSciences LLC) is mixed with one or more water-soluble agriculturally active ingredients dissolved in aqueous solution and/or one or more oil-soluble agriculturally active ingredients dissolved in oil solvent to form a coating liquid, without any polymeric binder. In some embodiments, the dissolved agriculturally active ingredient is the same as the agricultural active ingredient to be coated in a granule form. In other embodiments, the dissolved agriculturally active ingredient is different than the agricultural active ingredient to be coated in a granule form.

In some embodiments, the final suspension including the binder solution, one or more agricultural actives, one or more solvents, and the water suspension of encapsulated nitrapyrin is mixed for an additional period of time, preferably about 2 hours, prior to coating core 102 in order to arrive at a homogenous final suspension to coat core 102.

Core 102 can be coated by the final binder solutions or coating liquids above optionally inside a pan coater with a rotating drum. Other coating devices known in the art could also be used. A prescribed amount of bare cores, such as core 102, optionally AI granules, are first charged into a coater. Then, the final suspension including the binder solution are added to the pan coater and/or sprayed onto the granules. In one embodiment, the pan speed is kept at 60 rpm during the coating process. After addition of one or more of the final suspensions above, the coater is kept rotating, preferably for between about 5 and about 30 minutes. After these steps, core 102 with NI layer 106, optionally containing encapsulated nitrification inhibitor (and optionally AI such as fertilizer), is obtained.

After NI layer 106 is added to core 102, a hygroscopic particulate layer can be applied to NI layer 106. For example, after the coating liquid is evenly coated on core 102, HP powder, such as for example talc or diatomaceous earth, can be added to the pan coater under rotation. After addition of the HP, the pan can be kept rotating, preferably for about 10 minutes, to allow the HP to evenly coat on NI layer 106. One or more of such powders create HP layer 110. As shown, HP layer 110 is continuous around NI layer 106, however, in other embodiments HP layer 110 can be discontinuous around NI layer 106. Hygroscopic particulate may also be embedded in NI layer 106. Equipment that can be used to prepare combined particle 100 includes, but is not limited to a pan coater, a rotating drum, a spray coater, a fluid bed, and/or screens.

In some embodiments, NI-HP interface 108 around NI layer 106 is not explicit or neat, i.e. portions of HP layer 110 including hygroscopic particulate may be partially or substantially fully embedded within NI layer 106. In some embodiments, portions of HP layer 110 may be in contact with core 102. In other embodiments, HP layer 110 may not be in contact with core 102.

In many embodiments of the present disclosure, NI layer 106 and HP layer 110 are not discrete layers, but instead a mixed, inter-mixed, intermingled layer with NI and HP in a combined layer around NI interface 104.

Combined particle 100 can be dried, preferably at about 20 to about 80 degrees Celsius for about 10 to about 60 minutes to remove water and obtain the final dry combined particles. Alternatively, drying may be omitted. The coated fertilizer comprising combined particles can be applied without additional drying.

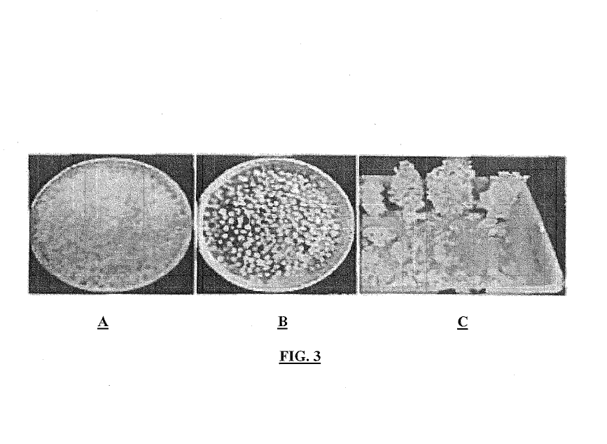

Referring now to FIGS. 3A-C, a photographic comparison of bare urea granules to exemplary combined particles of the present disclosure is provided. FIG. 3A shows bare urea, FIG. 3B shows the composition of Example 2 provided below, and FIG. 3C shows the composition of Example 4 provided below. The particle size and shape of the nitrapyrin-urea combined dry granules, FIGS. 3B-C, is similar to the bare urea particle size and shape. The particle size is about 2-4 mm in diameter. However, the urea granules of FIG. 3C for Example 4 (prepared without a particulate layer) were sticky and agglomerated to form big pieces of granule aggregates, which are difficult to process and apply.

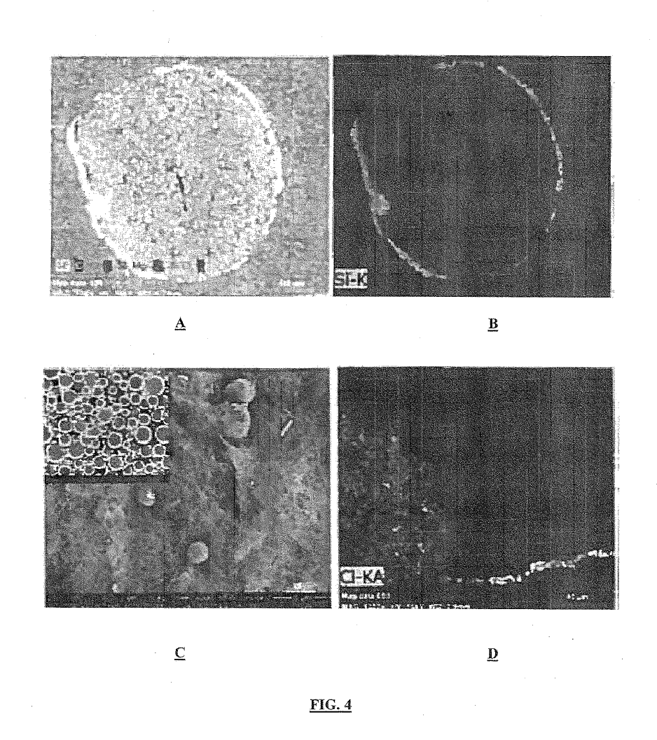

FIGS. 4A-D provide enlarged images of the morphology of the coated urea granule of Example 2 below. These images show the microstructure of the nitrapyrin-fertilizer dry granules produced in Example 2 below. The element mapping images for Si, Al, and Mg in the inorganic hygroscopic particulate layer, nitrogen from urea, and Cl from the active nitrapyrin are shown in FIGS. 4A, B, and D, respectively. The images indicate that the particulate was evenly coated on the surface of the fertilizer granules, and the polyurea-encapsulated nitrapyrin microcapsules were intact and imbedded in the coating layer; also, transfer of nitrapyrin from the microcapsules into the coating layer appeared to occur. FIG. 4C shows an SEM image of the coating layer of the coated urea, and the image insert is an image of the polyurea-encapsulated nitrapyrin particles.

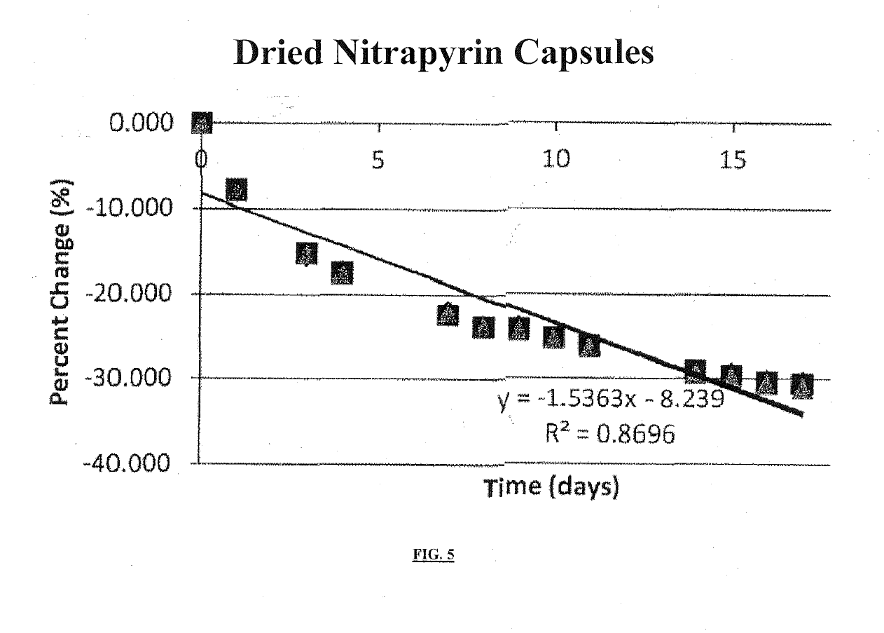

FIG. 5 provides a chart showing percent change in weight as a function of time of a dried Instinct® capsule suspension (polyurea-encapsulated nitrapyrin by Dow AgroSciences LLC) stored at 54° C. As shown, at about 2 weeks, 14 days at 54° C., the loss of nitrapyrin in weight percent is about 30%.

Examples of typical solvents which can be used to dissolve crystalline (trichloromethyl) pyridine compounds include aromatic solvents, particularly alkyl substituted benzenes such as xylene or propylbenzene fractions, and mixed naphthalene and alkyl naphthalene fractions; mineral oils; kerosene; dialkyl amides of fatty acids, particularly the dimethylamides of fatty acids such as the dimethyl amide of caprylic acid; chlorinated aliphatic and aromatic hydrocarbons such as 1,1,1-trichloroethane and chlorobenzene; esters of glycol derivatives, such as the acetate of the n-butyl, ethyl, or methyl ether of diethyleneglycol and the acetate of the methyl ether of dipropylene glycol; ketones such as isophorone and trimethylcyclohexanone (dihydroisophorone); and the acetate products such as hexyl or heptyl acetate. The preferred organic liquids are xylene, alkyl substituted benzenes, such as propyl benzene fractions, and alkyl naphthalene fractions.

In general, the amount of solvent employed, if desired, is typically from about 40, preferably from about 50 to about 75, preferably to about 60 weight percent, based on the total weight of a (trichloromethyl) pyridine/solvent solution. The amount of (trichloromethyl) pyridine within a (trichloromethyl) pyridine/solvent solution is typically from about 20, preferably from about 40 to about 60, preferably to about 50 weight percent, based on the weight of a (trichloromethyl) pyridine/solvent solution. In some embodiments of the present disclosure, nitrapyrin technical can be used in the formulation of combined particle 100, in any portion of combined particle 100. Nitrapyrin technical comprises about 90% to about 100% pure nitrapyrin depending on the impurity level. Therefore, in some embodiments the amount of solvent employed might be about 0% to about 10%, while the amount of nitrapyrin technical might be about 90% to about 100% pure.

The microcapsules useful in the present disclosure can be prepared by the polycondensation reaction of a polymeric isocyanate and a polyamine to form a polyurea shell. Methods of microencapsulation are well known in the art and any such method can be utilized in the present disclosure to provide a capsule suspension formulation. In general, the capsule suspension formulation can be prepared by first mixing a polymeric isocyanate with a (trichloromethyl)pyridine/solvent solution. This mixture is then combined with an aqueous phase which includes an emulsifier to form a two phase system. The organic phase is emulsified into the aqueous phase by shearing until the desired particle size is achieved. An aqueous crosslinking polyamine solution is then added drop-wise while stirring to form the encapsulated particles of (trichloromethyl)pyridine in an aqueous suspension.

The desired particle size and cell wall thickness will depend upon the actual application. The microcapsules typically have a volume median particle size of from about 1 to about 10 microns and a capsule wall thickness of from about 10 to about 125 nanometers. In some embodiments, the microcapsules have a volume median particle size of from about 1 to about 10 microns and a capsule wall thickness of from about 10 to about 150 nanometers. In one embodiment, the desired particle size may be from about 2 to about 10 microns, with a cell wall thickness of from about 10 to about 50 nanometers. In some embodiments, the desired particle size may be from about 2 to about 10 microns, with a cell wall thickness of from about 10 to about 25 nanometers.

In one embodiment, particularly requiring soil surface stability, the desired particle size may be from about 1-5 microns, with cell wall thicknesses of from about 50 to about 150 nanometers. In another embodiment, particularly requiring soil surface stability, the desired particle size may be from about 1-5 microns, with cell wall thicknesses of from about 75 to about 125 nanometers.

Other conventional additives may also be incorporated into the formulation such as emulsifiers, dispersants, thickeners, biocides, pesticides, salts and film-forming polymers.

Dispersing and emulsifying agents include condensation products of alkylene oxides with phenols and organic acids, alkyl aryl sulfonates, polyoxyalkylene derivatives of sorbitan esters, complex ether alcohols, mahogany soaps, lignin sulfonates, polyvinyl alcohols, and the like. The surface-active agents are generally employed in the amount of from about 1 to about 20 percent by weight of the microcapsule suspension formulation.

The ratio of the suspended phase to the aqueous phase within exemplary microcapsule suspension formulations of the present disclosure is dependent upon the desired concentration of (trichloromethyl) pyridine compound in the final formulation. Typically the ratio will be from about 1:0.60 to about 1:20. Generally the desired ratio is about 1:0.8 to about 1:9, and is preferably from about 1:0.8 to about 1:4.

The presence of a (trichloromethyl) pyridine compound suppresses the nitrification of ammonium nitrogen in the soil or growth medium, thereby preventing the rapid loss of ammonium nitrogen originating from nitrogen fertilizers, organic nitrogen constituents, or organic fertilizers and the like.

The enhanced nitrification inhibitor dry fertilizer compositions of the present disclosure can be applied in any manner which will benefit the crop of interest. In one embodiment the enhanced nitrification inhibitor dry fertilizer compositions are applied to growth mediums in a band or row application. In another embodiment, the compositions are applied to or throughout the growth medium prior to seeding or transplanting the desired crop plant. In yet another embodiment, the compositions can be applied to the root zone of growing plants.

Additionally, the compositions can be applied with the application of nitrogen fertilizers. The composition can be applied prior to, subsequent to, or simultaneously with the application of fertilizers.

The compositions of the present disclosure have the added benefit that they can be applied to the soil surface, without additional water or mechanical incorporation into the soil for days to weeks. Alternatively, if desired, the compositions of the present disclosure can be incorporated into the soil directly upon application.

The enhanced nitrification inhibitor dry fertilizer compositions of the present disclosure typically have a concentration of (trichloromethyl) pyridine compound in amounts of from about 0.01 to about 10, preferably from about 0.10 to about 5.00, and more preferably from about 0.10 to about 2.50, percent by weight, based on the total weight of the nitrification inhibitor dry fertilizer composition.

Soil treatment compositions may be prepared by dispersing the nitrification inhibitor dry fertilizer compositions in fertilizers such as ammonium or organic nitrogen fertilizer. The resulting fertilizer composition may be employed as such or may be modified, as by dilution with additional nitrogen fertilizer or with inert solid carrier to obtain a composition containing the desired amount of active agent for treatment of soil.

The soil may be prepared in any convenient fashion with the nitrification inhibitor dry fertilizer compositions of the present disclosure, including mechanically mixed with the soil; applied to the surface of the soil and thereafter dragged or diced into the soil to a desired depth; or transported into the soil such as by injection, spraying, dusting or irrigation. In irrigation applications, the nitrification inhibitor dry fertilizer composition may be introduced to irrigation water in an appropriate amount in order to obtain a distribution of the (trichloromethyl) pyridine compound to the desired depth of up to 6 inches (15.24 cm).

Due to the controlled release of nitrapyrin in the nitrification inhibitor dry fertilizer compositions of the present disclosure, several advantages can be attained. First, the amount of nitrapyrin can be reduced since it is more efficiently released into the soil over an extended period of time. Additionally, the nitrification inhibitor dry fertilizer composition of the present disclosure can be applied and left on the surface to be naturally incorporated into the soil, without the need for mechanical incorporation if desired.

Additionally, the nitrification inhibitor dry fertilizer compositions of the present disclosure can be combined or used in conjunction with pesticides, including arthropodicides, bactericides, fungicides, herbicides, insecticides, miticides, nematicides, nitrification inhibitors such as dicyandiamide, urease inhibitors such as N-(n-butyl) thiophosphoric triamide, and the like or pesticidal mixtures and synergistic mixtures thereof. In such applications, the nitrification inhibitor dry fertilizer compositions of the present disclosure can be mixed or blended with the desired pesticide(s) or they can be applied sequentially.

Exemplary herbicides include, but are not limited to acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester and the like.

Exemplary insecticides include, but are not limited to 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A &B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methyl sulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, vaniliprole, XMC, xylylcarb, zeta cypermethrin and zolaprofos.

Additionally, any combination of the above pesticides can be used. Additionally, Rynaxypyr™, a new anthranilic diamide (Chlorantraniliprole) crop protection chemistry from DuPont with efficacy in controlling target pests can be used.

The following examples are provided to illustrate the present invention. The examples are not intended to limit the scope of the present invention and they should not be so interpreted. Amounts are in weight parts or weight percentages unless otherwise indicated.

### Examples

In the following examples, nitrapyrin weight content in coated urea particles was detected by gas chromatography (“GC”). The instrument condition was aligned with DN 0025728 “Analytical method and validation for the determination of nitrapyrin in GF-2017 formulation.” The extraction process was according to the noted documentation, and based on solvent mix hexane/acetone (volume ratio from about 1:4 to about 4:1). The nitrapyrin content was analyzed before and after processing to calculate losses of nitrapyrin due to volatilization or chemical instability from the coated fertilizer particles.

To test storage stability of the coated fertilizer compositions, coated fertilizer granules were incubated in a Jar Mill (Lindberg/Blue M, Thermal Electron Corporation) at 54 degrees Celsius for 2 weeks. After thermal treatment, nitrapyrin content loss was measured to demonstrate storage stability of nitrapyrin coated fertilizer granules.

Nitrapyrin content detection method. The nitrapyrin coated fertilizer granules were dissolved in saturated NaCl solution, and then extracted by acetone/hexane in a 4:1 mixture. The extract was analyzed by the above-mentioned GC method. The method was validated by a recovery test method. For each sample, the nitrapyrin content (referred to as Nitrification Inhibitor “NI” content in the Tables below) was tested for 3 times; then the average of 3 data points was calculated.

Table 1 provides the raw materials used to make the exemplary compositions provided in the Tables that follow.

TABLE 1
Raw Materials for exemplary compositions.

| Category | Ingredient | Supplier |
|---|---|---|
| Active | Entrench ® | The Dow Chemical Company, Midland, |
| source | (Polyurea encapsulated | U.S.A. |
| | aqueous suspension) | |
| Fertilizer | Urea | Sinopharm Chemical Reagent Co., Ltd. |
| | | Shanghai, China. |
| Binder | PVA (polyvinyl alcohol) | Dongfang Chemical Company, Beijing. China |
| | HPMC (hydroxypropyl | The Dow Chemical Company, Midland, |
| | methylcellulose) K99 | U.S.A. |
| Particulate | ATP (attapulgite) | Jiu Chuan company, Jiang Su China |
| | Kaolin | Sinopharm Chemical Reagent Co. |
| | Talc | Sinopharm Chemical Reagent Co. |
| | Diatomite | Sinopharm Chemical Reagent Co. |

Table 2 provides a variety of formulations for exemplary coating liquids to create binder layers.

TABLE 2
Formulations of Coating Liquids.

| Coating | | Binder | | | | Composition of the | | |
|---|---|---|---|---|---|---|---|---|
| liquid | Entrench | Binder | Binder | Urea | Total | coating liquid | | |
| No. | (g) | Type | wt (g) | (g) | (g) | Urea % | NI* % | Binder % |
| 1 | 40.01 | HPMC | 0.50 | 37.76 | 100.04 | 37.74 | 7.11 | 0.50 |
| | | K99 | | | | | | |
| 2 | 24.00 | HPMC | 0.20 | 12.69 | 40.01 | 31.71 | 10.67 | 0.50 |
| | | K99 | | | | | | |
| 3 | 16.00 | / | 0.00 | 15.21 | 40.04 | 37.99 | 7.11 | 0.00 |
| 4 | 16.00 | PVA | 0.20 | 15.10 | 40.00 | 37.75 | 7.12 | 0.50 |
| | | 1788 | | | | | | |
| 5 | 16.04 | HPMC | 0.20 | 15.11 | 40.08 | 37.71 | 7.12 | 0.50 |
| | | K99 | | | | | | |
| 6 | 40.0 | / | / | / | 40.0 | / | 17.79 | / |

*NI is nitrification inhibiting ingredient, the nitrification inhibiting ingredient is nitrapyrin

Table 3 provides exemplary formulations of particulate coatings and compositions of final Entrench/urea fertilizers.

TABLE 3
Formulations of particulate coating and compositions of final polyurea
encapsulated nitrapyrin/urea fertilizer.

| | Coating Liquid | | | | | | | | | |
|---|---|---|---|---|---|---|---|---|---|---|
| | Coating | | | Core | Particulate | | Composition of final Entrench/ | | | |
| | liquid | Binder | | urea | Particulate | Wt | urea dry fertilizer | | | |
| Examples | No. | type | Wt (g) | Wt (g) | type | (g) | NI % | Binder % | Urea % | Particulate % |
| 1 | 1 | HPMC | 8.59 | 300.35 | ATP* | 6.02 | 0.20 | 0.01 | 97.39 | 1.93 |
| | | K99 | | | | | | | | |
| 2 | 1 | HPMC | 17.04 | 300.40 | ATP | 14.30 | 0.37 | 0.03 | 94.32 | 4.39 |
| | | K99 | | | | | | | | |
| 3 | 2 | HPMC | 16.88 | 300.23 | ATP | 11.16 | 0.56 | 0.03 | 94.64 | 3.46 |
| | | K99 | | | | | | | | |
| 4 | 1 | HPMC | 8.61 | 300.44 | / | / | 0.20 | 0.01 | 99.31 | / |
| | | K99 | | | | | | | | |
| 5 | 3 | / | 16.60 | 300.29 | ATP | 12.68 | 0.36 | / | 94.85 | 3.92 |
| 6 | 4 | PVA | 16.83 | 300.85 | ATP | 14.88 | 0.37 | 0.03 | 94.18 | 4.56 |
| | | 1788 | | | | | | | | |
| 7 | 1 | HPMC | 16.88 | 300.72 | Kaolin | 19.18 | 0.36 | 0.03 | 92.94 | 5.80 |
| | | K99 | | | | | | | | |
| 8 | 5 | HPMC | 16.90 | 300.40 | Talc | 18.89 | 0.36 | 0.03 | 93.02 | 5.73 |
| | | K99 | | | | | | | | |
| 9 | 5 | HPMC | 16.88 | 300.30 | Diatomite | 18.34 | 0.37 | 0.03 | 93.17 | 5.57 |
| | | K99 | | | | | | | | |
| 10** | 6 | / | 17.50 | 300.10 | Diatomite | | 0.96 | / | 92.17 | 4.61 |
| 11** | 6 | / | 25.57 | 300.03 | Diatomite | | 1.34 | / | 88.10 | 7.39 |
| 12^{a} | 2 | HPMC | 16.83 | 300.28 | Diatomite | 13.42 | 0.55 | 0.03 | 94.00 | 4.13 |
| | | K99 | | | | | | | | |
| 13^{b} | 2 | HPMC | 16.99 | 300.28 | Diatomite | 11.94 | 0.56 | 0.03 | 94.40 | 3.63 |
| | | K99 | | | | | | | | |
| 14^{c} | 2 | HPMC | 16.79 | 300.28 | Diatomite | 9.13 | 0.56 | 0.03 | 95.25 | 2.80 |
| | | K99 | | | | | | | | |

*ATP is attapulgite
**Time taken to conduct the Entrench coating was ~30 min
^{a}Core particle is NPK fertilizer;
^{b}Core particle is KCl fertilizer;
^{c}Core particle is calcium phosphate fertilizer

Table 4 provides the density of the exemplified polyurea encapsulated nitrapyrin-urea dry fertilizers. The density of bare urea is about 1.30 g/cm³, and that of the exemplified combined-particle fertilizer granules was about 1.32-1.371 g/cm³. As the density of bare urea and coated urea were similar, dry blending of uncoated and coated urea, or other agricultural actives, appears favorable and without the risk of granule classification.

TABLE 4
Density of the polyurea encapsulated nitrapyrin-urea dry fertilizer.

| | Density |
|---|---|
| Sample No. | (g/cm³) |
| Bare urea | 1.30 |
| Example 1 | 1.34 |
| Example 2 | 1.36 |
| Example 7 | 1.35 |
| Example 8 | 1.37 |
| Example 9 | 1.32 |

Table 5 provides the nitrification inhibitor “NI” (nitrapyrin) content after processing and storage. Considering the high relative volatility of nitrapyrin (2.8×10⁻³ mm Hg at 23° Celsius), the loss of nitrapyrin is a key to evaluating the ability of the exemplified combined particles to retain nitrapyrin during processing and storage. To compare the nitrapyrin stability and retention between various formulations, the calculated nitrapyrin content applied in each formulation was normalized to 100% and the nitrapyrin content measured after processing was normalized based on the theoretical content.

TABLE 5
NI content of combined particles after processing and storage

| | | | | | | | NI wt % |
|---|---|---|---|---|---|---|---|
| | | | | | | NI wt % after | after |
| | | | | | | stored @ 54° C. | stored @ |
| | Theoretical | | | Theoretical | NI wt % after | for 1 | 54° C. for |
| | NI | | | NI wt % | processing | week | 2 week |
| Examples | wt % | Binder | Particulate | (normalized) | (normalized) | (normalized) | (normalized) |
| 1 | 0.20 | HPMC K99 | ATP | 100% | 87.2 | 78.0 | 75.7 |
| 2 | 0.37 | HPMC K99 | ATP | 100% | 90.5 | 87.9 | 79.0 |
| 3 | 0.56 | HPMC K99 | ATP | 100% | 92.5 | 91.6 | 90.6 |
| 4 | 0.20 | HPMC K99 | / | 100% | 78.1 | 62.9 | 57.3 |
| 5 | 0.36 | / | ATP | 100% | 93.7 | 87.3 | 85.4 |
| 6 | 0.37 | PVA 1788 | ATP | 100% | 98.3 | 87.5 | 77.5 |
| 7 | 0.36 | HPMC K99 | Kaolin | 100% | 88.6 | 83.2 | 87.1 |
| 8 | 0.36 | HPMC K99 | Talc | 100% | 94.0 | 94.5 | 78.4 |
| 9 | 0.37 | HPMC K99 | Diatomite | 100% | 99.5 | 90.1 | 84.9 |
| 10 | 0.96 | / | Diatomite | 100% | / | / | 95.8 |
| 11 | 1.34 | / | Diatomite | 100% | / | / | ~100 |
| 12^{a} | 0.55 | HPMC | Diatomite | 100% | 102.2 | / | 88.5 |
| 13^{b} | 0.56 | HPMC | Diatomite | 100% | 94.6 | 91.1 | 87.5 |
| 14^{c} | 0.56 | HPMC | Diatomite | 100% | 101.8 | 92.9 | 89.9 |
| 15 | 0.09 | / | / | 100% | 97.8 | N/A | 49.5 |

^{a}Core particle is NPK fertilizer;
^{b}Core particle is KCl fertilizer;
^{C}Core particle is calcium phosphate fertilizer

The effect of nitrapyrin loading level in the dry formulation is shown in Table 5. In examples 1-3, the nitrapyrin content after processing increased from 87.2 wt % to 92.5 wt % as nitrapyrin loading level in the dry formulation increases from 0.2 wt % to 0.56 wt %. Example 15 was carried out by mixing urea granules with encapsulated nitrapyrin liquid emulsion at theoretical NI of 0.09%. This was roughly equivalent to a nitrapyrin concentration with field application rates of 500 lbs/acre urea with 35 oz/acre Entrench®. The NI retention was about 49% after 2 weeks at 54° C.

Still referring to Table 5, the hygroscopic particulate appears to affect nitrapyrin retention during processing. In Example 4, no particulate was used, and in other Examples (1-3 and 5-9) hygroscopic particulate was used in the dry formulation, including ATP, talc, Kaolin and diatomite. In the Examples with hygroscopic particulate, the nitrapyrin content after processing was 87-94%, while in the Example without hygroscopic particulate, nitrapyrin was 78%. So, hygroscopic particulate has a significant contribution in improving nitrapyrin retention during processing.

As shown by FIG. 5, at about 2 weeks/14 days at 54° C., the loss of nitrapyrin in weight percent is about 30% for dried Instinct® capsules (microencapsulated nitrapyrin in polyurea, typically in an aqueous suspension).

Still referring to Table 5, in Examples 2, 5 and 6 (the active loading level: 0.37%, particulate: ATP), a different binder was employed. Regarding nitrapyrin retention during storage, the retention of NI during storage was evaluated by storing the examples in an oven at 54 degree Celsius for 1 week and 2 weeks.

Still referring to Table 5, the hygroscopic particulate appears to boost nitrapyrin retention during processing. In Example 4, as no particulate was used, the nitrapyrin content measured after storage at 54 degree Celsius for 2 weeks was only 57%. When hygroscopic particulate such as attapulgite, talc, kaolin and diatomite, were introduced the nitrapyrin content after storage was more than 76%. The type of particulate appears to have little effects on the levels of nitrapyrin retained, with attapulgite and diatomite showing the best performance.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

What is claimed is:

1. An agriculturally active composition, comprising:
a substantially solid core, the core having an outer surface;
a plurality of encapsulated particles disposed around the outer surface, the particles including at least one inhibitor of nitrification; and
hygroscopic particulate disposed around the plurality of encapsulated particles.

2. The composition according to claim 1, wherein the hygroscopic particulate is not in contact with the core.

3. The composition according to claim 1, wherein the core is at least one agricultural active ingredient selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof.

4. The composition according to claim 3, wherein the core comprises a solid form of urea.

5. The composition according to claim 1, wherein the encapsulated particles comprise nitrapyrin.

6. The composition according to claim 5, wherein the encapsulated particles include polyurea and have a volume median particle size of from about 1 to about 10 microns.

7. The composition according to claim 1, wherein the hygroscopic particulate is an inorganic hygroscopic particulate.

8. The composition according to claim 1, wherein the hygroscopic particulate is at least one compound selected from the group consisting of: attapulgite, talc, diatomite, kaolin, silica, clay, mica, bentonite, montmorillonite, white carbon black, carbon black, coal ash, plant ash, wollastonite, zeolite, sepiolite, vermiculite perlite, starch, wax, and mixtures thereof.

9. The composition according to claim 1, further comprising a binder, said binder being disposed predominately on the outer surface of the core and said binder immobilizing the plurality of the encapsulated particles.

10. The composition according to claim 9, wherein the binder is at least one compound selected from the group consisting of: hydroxypropyl methylcellulose, ethyl cellulose, methyl cellulose, carboxymethyl cellulose, polyvinyl alcohol, polyvinylpyrrolidone, polyoxyethylene and its copolymers, latexes, polyamides, sugar, glucose, maltose, starch, lignosulfonates, guar, urea, alginate, polysaccharides, aqueous polyester, polyethers, epoxy resin, isocyanates, ethylene vinyl acetate copolymer, polyacrylate and its copolymer emulsions, and mixtures thereof.

11. The composition according to claim 10, wherein the binder comprises hydroxypropyl methylcellulose.

12. The composition according to claim 1, wherein the composition comprises between about 80% and about 99% by weight of fertilizer granules.

13. The composition according to claim 1, wherein the composition comprises between about 90% and about 99% by weight of fertilizer granules.

14. The composition according to claim 1, wherein the composition comprises nitrapyrin in a range selected from the group of ranges consisting of: about 0.01% wt. to about 10.00% wt.; about 0.05% wt. to about 5.00% wt.; about 0.10% wt. to about 4.00% wt.; about 0.20% wt. to about 3.00% wt.; about 0.30% wt. to about 2.50% wt.; about 0.40% wt. to about 2.00% wt.; and about 0.50% wt. to about 1.00% wt.

15. The composition according to claim 1, wherein the composition comprises between about 0.20% and about 2.00% of nitrapyrin.

16. The composition according to claim 9, wherein the composition comprises between about 0.01% and about 10% of the binder.

17. The composition according to claim 9, wherein the composition comprises between about 0.01% and about 5% of the binder.

18. The composition according to claim 1, wherein the composition comprises between about 1.00% and about 10.00% of the hygroscopic particulate.

19. The composition according to claim 1, wherein the composition comprises between about 2.00% and about 7.00% of the hygroscopic particulate.

20. The composition according to claim 1, wherein the composition comprises particles of a volume median particle size of from about 0.5 to about 5 millimeters.

21. The composition according to claim 9, wherein the ratio of the binder to the agriculturally active ingredient is from about 0:100 to about 1:100.

22. The composition according to claim 9, wherein the ratio of the binder to the agriculturally active ingredient is from about 0:100 to about 0.3:100.

23. The composition according to claim 3, wherein the ratio of the inhibitor of nitrification to the fertilizer is from about 0.01:100 to about 3:100.

24. The composition according to claim 3, wherein the ratio of the inhibitor of nitrification to the fertilizer is from about 0.2:100 to about 2.0:100.

25. The composition according to claim 3, wherein the ratio of the hygroscopic particulate to the fertilizer is from about 1:500 to about 20:100.

26. The composition according to claim 3, wherein the ratio of the hygroscopic particulate to the fertilizer is from about 1:100 to about 10:100.

27. A method for preparing an agriculturally active composition comprising the steps of:
preparing a solution comprising a plurality of encapsulated particles, the particles including at least one inhibitor of nitrification; and
coating a plurality of substantially solid core particles, the core particles having an outer surface, with the solution to create coated combined particles.

28. The method according to claim 27, further comprising the step of adding a binder to the solution.

29. The method according to claim 27, wherein the preparing step further comprises dissolving fertilizer granules within the solution.

30. The method according to claim 27, further comprising the step of drying the combined particles.

31. The method according to claim 27, wherein the core particle is at least one compound selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof.

32. The method according to claim 27, wherein the core particles comprise urea.

33. The method according to claim 27, wherein the encapsulated particles comprise nitrapyrin.

34. The method according to claim 27, wherein the encapsulated particles comprise polyurea and have a volume median particle size of from about 1 to about 10 microns.

35. The method according to claim 28, wherein the binder is at least one compound selected from the group consisting of: hydroxypropyl methylcellulose, ethyl cellulose, methyl cellulose, carboxymethylcellulose, polyvinyl alcohol, polyvinylpyrrolidone, polyoxyethylene and its copolymers, latexes, polyamides, sugar, glucose, maltose, starch, guar, urea, alginate, polysaccharides, aqueous polyester, polyethers, epoxy resin, isocyanates, ethylene vinyl acetate copolymer, polyacrylate and its copolymer emulsions, and mixtures thereof.

36. The method according to claim 35, wherein the solution comprises hydroxypropyl methylcellulose, polyvinyl alcohol, and water.

37. The method according to claim 27, further comprising the step of adding hygroscopic particulate to be disposed on the coated combined particles.

38. The method according to claim 37, wherein the hygroscopic particulate is inorganic hygroscopic particulate.

39. The method according to claim 37, wherein the hygroscopic particulate is at least one compound selected from the group consisting of: attapulgite, talc, diatomite, kaolin, silica, clay, mica, bentonite, montmorillonite, white carbon black, carbon black, coal ash, plant ash, wollastonite, zeolite, sepiolite, vermiculite perlite, starch, wax, and mixtures thereof.

40. The method according to claim 27, wherein the composition comprises between about 80% and about 99% by weight of core particles.

41. The method according to claim 27, wherein the composition comprises between about 90% and about 99% by weight of core particles.

42. The method according to claim 27, wherein the composition comprises nitrapyrin in a range selected from the group consisting of: about 0.01% wt. to about 10.00% wt.; about 0.05% wt. to about 5.00% wt.; about 0.10% wt. to about 4.00% wt.; about 0.20% wt. to about 3.00% wt.; about 0.30% wt. to about 2.50% wt.; about 0.40% wt. to about 2.00% wt.; and about 0.50% wt. to about 1.00% wt.

43. The method according to claim 27, wherein the composition comprises between about 0.20% and about 2.00% of nitrapyrin.

44. The method according to claim 28, wherein the composition comprises between about 0.01% and about 10.00% of the binder.

45. The method according to claim 25, wherein the composition comprises between about 0.01% and about 5.00% of the binder.

46. The method according to claim 37, wherein the composition comprises between about 1.00% and about 10.00% of the hygroscopic particulate.

47. The method according to claim 37, wherein the composition comprises between about 2.00% and about 7.00% of the hygroscopic particulate.

48. The method according to claim 27, wherein the composition comprises coated combined particles of a volume median particle size of from about 0.5 to about 5 millimeters.

49. The method according to claim 28, wherein the ratio of the binder to the core particles is from about 0:100 to about 1:100.

50. The method according to claim 28, wherein the ratio of the binder to the core particles is from about 0:100 to about 0.3:100.

51. The method according to claim 27, wherein the ratio of the inhibitor of nitrification to the core particles is from about 0.01:100 to about 3:100.

52. The method according to claim 27, wherein the ratio of the inhibitor of nitrification to the core particles is from about 0.2:100 to about 2.0:100.

53. The method according to claim 37, wherein the ratio of the hygroscopic particulate to the core particles is from about 1:500 to about 20:100.

54. The method according to claim 36, wherein the ratio of the hygroscopic particulate to the core particles is from about 1:100 to about 10:100.

55. The method according to claim 26, wherein the step of coating incorporates one or more devices selected from the group consisting of: a pan coater, a rotating drum, a spray coater, a fluid bed, screens, and mixtures thereof.

56. An agriculturally active composition, comprising:
a substantially solid core, the core having an outer surface;
at least one inhibitor of nitrification disposed around the outer surface; and
hygroscopic particulate disposed around the at least one inhibitor of nitrification.

57. The composition according to claim 56, wherein the at least one inhibitor of nitrification comprises a plurality of encapsulated particles.

58. The composition according to claim 56, wherein the hygroscopic particulate is not in contact with the core.

59. The composition according to claim 56, wherein the core is at least one agricultural active ingredient selected from the group consisting of: a nitrogen-based fertilizer, a potassium-based fertilizer, a phosphorus-based fertilizer, a zinc-containing micronutrient fertilizer, a copper-containing micronutrient fertilizer, a boron-containing micronutrient fertilizer, an iron-containing micronutrient fertilizer, a manganese-containing micronutrient fertilizer, a sulfur-containing micronutrient fertilizer, and mixtures thereof.

60. The composition according to claim 59, wherein the core comprises a solid form of urea.

61. The composition according to claim 57, wherein the encapsulated particles comprise nitrapyrin.

62. The composition according to claim 57, wherein the encapsulated particles include polyurea and have a volume median particle size of from about 1 to about 10 microns.

63. The composition according to claim 56, wherein the hygroscopic particulate is an inorganic hygroscopic particulate.

64. The composition according to claim 56, wherein the hygroscopic particulate is at least one compound selected from the group consisting of: attapulgite, talc, diatomite, kaolin, silica, clay, mica, bentonite, montmorillonite, white carbon black, carbon black, coal ash, plant ash, wollastonite, zeolite, sepiolite, vermiculite perlite, starch, wax, and mixtures thereof.

65. The composition according to claim 56, further comprising a binder, said binder being disposed predominately on the outer surface of the core and said binder immobilizing the plurality of the encapsulated particles.

66. The composition according to claim 65, wherein the binder is at least one compound selected from the group consisting of: hydroxypropyl methylcellulose, ethyl cellulose, methyl cellulose, carboxymethyl cellulose, polyvinyl alcohol, polyvinylpyrrolidone, polyoxyethylene and its copolymers, latexes, polyamides, sugar, glucose, maltose, starch, lignosulfonates, guar, urea, alginate, polysaccharides, aqueous polyester, polyethers, epoxy resin, isocyanates, ethylene vinyl acetate copolymer, polyacrylate and its copolymer emulsions, and mixtures thereof.

67. The composition according to claim 66, wherein the binder comprises hydroxypropyl methylcellulose.

68. The composition according to claim 56, wherein the composition comprises between about 80% and about 99% by weight of fertilizer granules.

69. The composition according to claim 56, wherein the composition comprises between about 90% and about 99% by weight of fertilizer granules.

70. The composition according to claim 56, wherein the composition comprises nitrapyrin in a range selected from the group of ranges consisting of: about 0.01% wt. to about 10.00% wt.; about 0.05% wt. to about 5.00% wt.; about 0.10% wt. to about 4.00% wt.; about 0.20% wt. to about 3.00% wt.; about 0.30% wt. to about 2.50% wt.; about 0.40% wt. to about 2.00% wt.; and about 0.50% wt. to about 1.00% wt.

71. The composition according to claim 56, wherein the composition comprises between about 0.20% and about 2.00% of nitrapyrin.

72. The composition according to claim 65, wherein the composition comprises between about 0.01% and about 10% of the binder.

73. The composition according to claim 65, wherein the composition comprises between about 0.01% and about 5% of the binder.

74. The composition according to claim 56, wherein the composition comprises between about 1.00% and about 10.00% of the hygroscopic particulate.

75. The composition according to claim 56, wherein the composition comprises between about 2.00% and about 7.00% of the hygroscopic particulate.

76. The composition according to claim 56, wherein the composition comprises particles of a volume median particle size of from about 0.5 to about 5 millimeters.

77. The composition according to claim 65, wherein the ratio of the binder to the agriculturally active ingredient is from about 0:100 to about 1:100.

78. The composition according to claim 65, wherein the ratio of the binder to the agriculturally active ingredient is from about 0:100 to about 0.3:100.

79. The composition according to claim 59, wherein the ratio of the inhibitor of nitrification to the fertilizer is from about 0.01:100 to about 3:100.

80. The composition according to claim 59, wherein the ratio of the inhibitor of nitrification to the fertilizer is from about 0.2:100 to about 2.0:100.

81. The composition according to claim 59, wherein the ratio of the hygroscopic particulate to the fertilizer is from about 1:500 to about 20:100.

82. The composition according to claim 59, wherein the ratio of the hygroscopic particulate to the fertilizer is from about 1:100 to about 10:100.
